(19) United States
(12) Patent Application Publication
(10) Pub. No.: US 2007/0180711 A1
(43) Pub. Date: Aug. 9, 2007

(54) Jigsaw actuation mechanism for imparting scrolling, orbital and reciprocating movement

(76) Inventor: Keith Park, Ellerton (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/261,417

(22) Filed: Oct. 28, 2005

Related U.S. Application Data
(63) Continuation-in-part of application No. 10/665,577, filed on Sep. 19, 2003.

(51) Int. Cl. B23D 49/00

(52) U.S. Cl. 30/393; 30/392

(57) ABSTRACT

A jigsaw is provided including a housing and a drive mechanism disposed within the housing. The drive mechanism is provided with a mechanical connection for selectively imparting a reciprocating, scrolling and/or orbital motion to a drive shaft of the jigsaw and/or to a saw blade attached to the drive shaft of the jigsaw during use thereof. The jigsaw includes a support member for selective engagement with a part of the saw blade to provide support to the blade during the reciprocal, scrolling and/or orbital motion.

### REFERENCE TO RELATED APPLICATIONS

The present application is a continuation-in-part of U.S. patent application Ser. No. 10/665,577 (Park), filed on Sep. 19, 2003, which is hereby incorporated by reference in its entirety.

### BACKGROUND

This application is directed to improvements relating to jigsaws, including in one aspect clamping apparatus for clamping a saw blade to the jigsaw in use, in a second aspect a support mechanism for supporting a saw blade attached to the jigsaw during one or more operations of the jigsaw, in a further aspect a scrolling mechanism for allowing scrolling of the jigsaw in at least one operation mode of the jigsaw, and in a yet further aspect a movement actuation mechanism for imparting scrolling, orbital and/or reciprocating movement to a drive shaft of the jigsaw.

It will be appreciated by persons skilled in the art that the different aspects of the present invention can be used together and/or independently of each other. In addition, whilst the following description refers almost exclusively to apparatus and mechanism for use with a jigsaw, it will be appreciated that the inventive aspects can be used with any cutting tool.

Tools, such as jigsaws, power saws or reciprocating saws, are typically provided with releasable blade clamping means for allowing saw blades to be replaced, removed and/or repaired as and when required. There are many different types of blade clamping means available and one example is disclosed in EP0587498 wherein a support is provided on a slideway which defines an engagement passage for a tail end of a saw blade. A retractable locking member is secured to the support and interacts directly with a protrusion portion on the saw blade. In order for a user to release the blade, they are required to move the retractable locking member. Since this release mechanism requires the user to directly come into contact with the blade, if the user accidentally slips during this maneuver they are likely to cut themselves on the blade, which is undesirable.

A further example of a blade clamping arrangement is disclosed in DE4313718. In this arrangement, two clamping jaws are provided which are radially movable relative to the longitudinal axis of a blade stroke shaft. In a clamped position jaws are pressed against opposite flat sides of the blade by a wedge mechanism. The wedge mechanism is formed by a screwcap having an inner conical surface. The outer surfaces of the clamping jaws are shaped so that movement of the screw cap with respect to the jaws moves the jaws between clamped and unclamped positions. Since the blade release mechanism is likely to require multiple rotations of the screw cap to move the same between the clamped and unclamped positions, this increases the time taken for a user to attach or release a blade. A problem associated with other blade clamping arrangements includes the requirement of special tools to enable the release and/or attachment of the blade to the tool.

It is known to provide Jigsaws which are capable of undergoing reciprocal motion, wherein the drive shaft and thus the saw blade attached thereto are caused to move in a forwards and backwards direction along a line of operation substantially parallel to the longitudinal axis of the drive shaft, scrolling motion, wherein the drive shaft and thus the saw blade attached thereto are capable of undergoing rotational movement about the longitudinal axis of the drive shaft, and orbital motion, wherein the drive shaft and thus the saw blade attached thereto are caused to undergo a pendulum type of motion by a forwards or lateral motion component being imparted to a reciprocal blade.

A problem encountered during orbital operation of the saw blade is that due to the distance of the cutting portion of the blade from the drive means driving the orbital motion of the drive shaft or from the pivotal point of the drive shaft, the saw blade is caused to undergo adverse flexing, thereby producing both an inaccurate and inefficient cutting action.

### SUMMARY

It is therefore an object of the present invention to provide a clamping arrangement for a tool component of a jigsaw, such as a saw blade, which allows quick and easy release of the component in a single step therefrom without requiring the user to manipulate the component directly to actuate release thereof.

It is a further object of the present invention to provide a support mechanism for a saw blade of a jigsaw to provide improved support for the blade, particularly during orbital operation of the jigsaw.

It is a yet further object of the present invention to provide a movement actuation mechanism for a jigsaw for imparting scrolling, reciprocal and/or orbital motion to a drive shaft and/or saw blade attached to the drive shaft.

It is a yet further object of the present invention to provide a scrolling mechanism for a jigsaw to allow improved scrolling of the same.

It is a further object of the present invention to provide an improved orbital cutting mechanism which provides improved support for the blade and which allows a user to quickly and easily move a tool to an orbital cutting mode from a further working mode, such as a reciprocating or scrolling cutting mode.

According to a first aspect of the present invention there is provided clamping apparatus for a saw blade, the clamping apparatus including one or more clamping members, the one or more clamping members movable between a clamped position, wherein at least a portion of the saw blade is secured in a required position in use, and an unclamped position, wherein at least a portion of the saw blade is movable with respect to the clamping members, the clamping apparatus including user actuation means for actuating movement of the clamping members between the clamped position and the unclamped position, characterized in that the user actuation means is slidably mounted on the apparatus.

Thus, sliding movement of the user actuation means relative to the one or more clamping members causes the clamping members to move between the clamped and unclamped positions. In the latter position, the saw blade can be quickly released for replacement and/or repair.

Preferably the user actuation means is capable of undergoing reciprocal linear sliding motion to move the clamping members between the clamped and unclamped positions.

The user actuation means is typically associated with resilient biasing means which biases the user actuation means and thus the clamping members to the clamped position. The resilient biasing means typically includes a spring, spring loaded mechanism and/or the like. A user is required to move the user actuation means in such a manner so as to overcome the biasing force and move the clamping members to the unclamped position.

The user actuation means can be slidably mounted on the clamping members and/or a body portion. In the latter embodiment the clamping members are typically located between the body portion and the actuation means.

The body portion is typically attached to a shank or reciprocating arm to provide reciprocating movement of the saw blade in use.

Preferably the user actuation means is in the form of a sleeve. The sleeve can be annular, partially annular or non-annular in shape.

Preferably the clamping members are pivotally mounted in the apparatus and undergo pivotal or rotational movement between the clamped and unclamped positions.

The clamping members preferably move radially with respect to the longitudinal axis of the clamping apparatus. More specifically, sliding movement of the user actuation means causes movement of the clamping members radially outwardly of the apparatus to the unclamped position and radially inwardly of the apparatus to the clamped position.

In one embodiment, one or more inner surfaces of the user actuation means and/or outer surfaces of the clamping members include cam means to provide relative movement between the user actuation means and the clamping members.

Preferably the outer surfaces of the clamping members are tapered outwardly from the pivot point to the opposite outer edge.

In one embodiment at least one of the clamping members includes at least one recess portion in which a first protruding portion of the saw blade locates in the clamped position.

Preferably the clamping apparatus includes a blade location member in which at least one location port is provided for location of a further protruding portion of the saw blade therein. The blade location member can be integrally formed with the body portion or attached thereto.

The at least one recess portion of the clamping member and the at least one location port of the blade location member are typically a spaced distance apart. The spaced distance apart is typically equivalent to the distance between the first and further protruding portions of the saw blade.

In a preferred embodiment two clamping members are provided and are movable relative to each other between the clamped and unclamped positions. Each clamping member can be provided with a recess portion along an edge thereof, such that in a clamped position the recess portions of the clamping members are located on adjacent edges to define a larger recess portion.

Preferably the saw blade has a t-shaped formation at one end, thereby providing two diametrically opposed protruding portions on opposite edges of the blade.

According to a second aspect of the present invention there is provided a jigsaw, the jigsaw including a housing and a drive mechanism disposed within the housing, the drive mechanism being provided with a mechanical connection for selectively imparting a reciprocating, scrolling and orbital motion to a drive shaft of the jigsaw and/or a saw blade attached to the drive shaft of the jigsaw during use thereof, and wherein the jigsaw includes a support member for selective engagement with a part of the saw blade to provide support to the blade during the reciprocal, scrolling and/or orbital motion.

Preferably the support member engages the saw blade during orbital operation of the jigsaw. The support member can be moved out of engagement with the saw blade during reciprocal and/or scrolling operations.

Preferably the support member is pivotally mounted on the jigsaw. The support member can be mounted to a part of the housing of the jigsaw or to a sole plate or foot plate of the jigsaw.

The support member can include a roller member and the roller member can engage a part of the saw blade in use.

The roller member can be mounted on a support arm and the support arm can be directly or indirectly pivotally mounted to a part of the jigsaw.

In one embodiment the support member drives, at least in part, the orbital motion of the saw blade during orbital operation of the jigsaw.

Preferably movement of the support member, and typically the pivotal movement of the support member is driven by a movement actuation mechanism. The movement actuation mechanism typically forms part of the drive mechanism and/or mechanical connection.

The drive mechanism and/or mechanical connection can include a reciprocal arm member and reciprocation of the reciprocal arm member causes the support member to undergo pivotal motion.

Preferably the reciprocal arm member can be brought into intermittent engagement with a part of the support member to cause the support member to undergo pivotal motion.

The support member is arranged to exert a force to the blade during orbital cutting. In one preferred embodiment, the support member is arranged to impart a force to a rear edge of the blade during orbital cutting motion. Typically the support member is selectively connected in the force path between the drive mechanism and the blade and is driven by the drive mechanism during orbital cutting so as to exert a varying force on the blade. Alternatively, the pivoting member may be arranged to passively support the blade during orbital motion by resisting orbital motion to a required degree.

Preferably the support member is mounted relative to the housing and is pivotable or rotatable between a first position, wherein the support member contacts the blade, and a second position, wherein the support member is a spaced apart distance from the blade.

Typically the blade is elongate in form and is attached to the drive shaft of the tool via clamping apparatus, typically in the vicinity of one end of the blade. The support member may selectively engage the blade a distance from the clamped end of the blade and preferably engagement between the blade and the support member occurs at a position between the end of the blade and a cutting point of the blade.

Preferably user selection means are provided on the tool to allow a user to select between the orbital, reciprocal and/or scrolling modes of operation of the jigsaw.

According to a further aspect of the present invention there is provided a movement actuation mechanism for a jigsaw.

According to a yet further aspect of the present invention there is provided a scrolling mechanism for a jigsaw, the jigsaw including a saw blade and the scrolling mechanism allowing movement of the saw blade between one or more required positions in use, the scrolling mechanism including at least first and second locking members, the locking members movable relative to each other between a first locked position, wherein the locking members are engaged and the position of the saw blade is substantially fixed, and a second unlocked position, wherein the locking members are disengaged and the position of the saw blade can be changed.

Preferably user actuation means are provided for movement of at least one of the first and second locking members, thereby resulting in relative movement of the first and second locking members between the locked and unlocked positions.

In one embodiment the first locking member is in the form of a locking arm or pin and the second locking member is in the form of a rotatable member having at least one recess in which the locking arm or pin located in the locked position.

Preferably the rotatable second locking member is connected directly or indirectly via mechanical connection means to the drive shaft of the saw blade, such that rotation of the second locking member by a user results in movement, and preferably co-axial rotation, of the saw blade to a required position.

In one embodiment, user actuation means in the form of a rotatable lever or knob is connected either directly or indirectly via mechanical connection means to the first locking member, such that rotation of the lever or knob results in rectilinear movement of the first locking member.

The advantage of the clamping apparatus of the present invention is that it is a one movement release, thereby allowing quick and easy release of the saw blade as and when required. The advantage of the scrolling mechanism of the present invention is that it is easy to operate.

The advantage of the support member of the present invention is that it supports the blade, particularly during orbital operation of the jigsaw to allow increased cutting efficiency and accuracy of the jigsaw.

### BRIEF DESCRIPTION OF THE DRAWINGS

Embodiments of the present invention will now be described with reference to the accompanying figures, wherein:

FIG. 1 is a perspective view of clamping apparatus according to an embodiment of the present invention in a clamped position with a saw blade;

FIG. 2 is an exploded view of the clamping apparatus and saw blade;

FIG. 3 is a simplified view showing the engagement of the saw blade with the clamping apparatus in a clamped position;

FIG. 4 is a simplified view of the internal components of a jigsaw showing the clamping apparatus and scrolling mechanism;

FIG. 5 is a perspective view of a jigsaw according to the present invention;

FIG. 6 is illustrates the support member and drive shaft of the jigsaw blade; and,

FIGS. 7a, 7b, 7c, and 7d show the main components of the movement actuation mechanism of the jigsaw according to the present invention with the outer housing of the jigsaw removed.

### DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

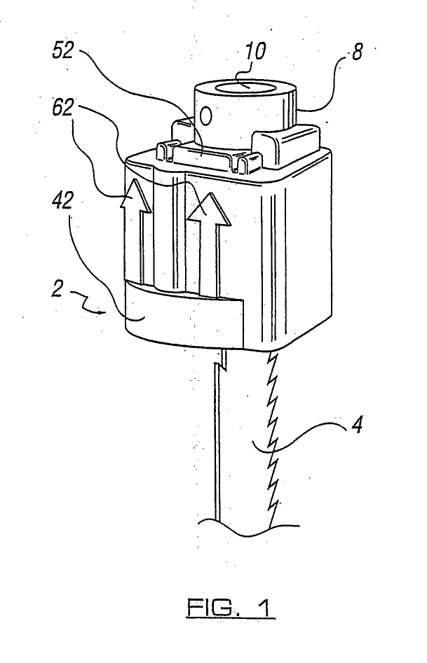

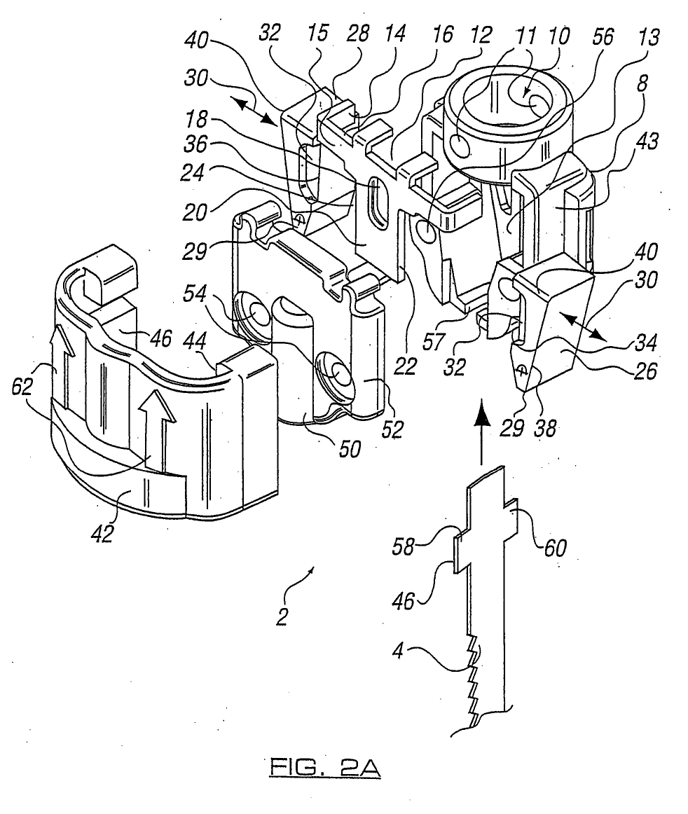

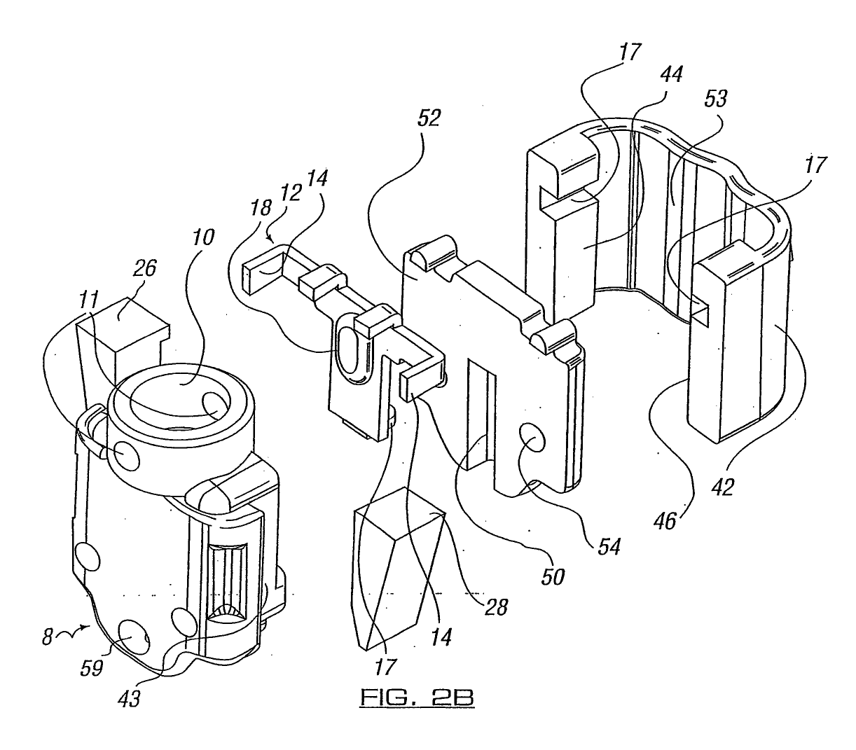

Referring firstly to FIGS. 1-3, there is illustrated a clamping apparatus 2 for releasably clamping a saw blade 4 for use in a power tool, such as a jigsaw 6.

The clamping apparatus 2 includes a body portion 8 having attachment means 10 for attachment of the clamping arrangement 2 to reciprocating means in the jigsaw 6, thereby allowing apparatus 2 and thus saw blade 4 to undergo reciprocating movement required for cutting/sawing when the tool is in use.

In this embodiment, the saw blade 4 has a t-shaped form including diametrically opposed protrusion portions at one end thereof for clamping in the clamping apparatus. The apparatus is movable between clamped and unclamped positions to secure or release/insert a blade respectively.

Blade location member 12 is attached to body portion 8 via a plurality of attachment arms 14. A location port in the form of aperture 18 is provided in blade location member 12 for the location of a protruding portion of saw blade 4. Blade location member 12 is provided in a t-shaped form with an arm portion 15 located at an upper end of a substantially central body panel 20 and protruding either side thereof. The attachment arms 14 are located along an upper edge 16 of the arm portion 15 and aperture 18 is located in the body panel 20.

Recesses 22, 24 are defined between the protruding portions of arm portion 15 and the sides of body panel 20. Each recess 22, 24 receives a clamping member 26, 28 respectively when the clamping members are located in a clamped position.

Clamping members 26, 28 are pivotally mounted in the apparatus between body portion 8/blade location member 12 and a slidably mounted sleeve 42. Movement of sliding sleeve 42 results in radial movement of clamping members 26, 28 with respect to the longitudinal axis of the clamping apparatus. Thus, members 26, 28 undergo opposite pivotal movement inwardly and outwardly of the apparatus 2, as shown by arrows 30, between clamped and unclamped positions respectively. The clamping members 26, 28 are pivoted about a lower edge 29 thereof.

Each clamping member 26, 28 has a recess portion 32 adjacent an inner side edge 34, 36 thereof. With the clamping members 26, 28 in a clamped position, inner side edges 34, 36 are in abutting relationship such that each recess portion 32 of the clamping members 26, 28 is joined to form a larger recess portion. The recess portions 32 are shaped such that the dimensions when joined are slightly larger than a protrusion portion of the blade.

Each clamping member 26, 28 is substantially wedge shaped with the outermost surface 38 of the members tapering outwardly from lower edge 29 to upper edge 40. User actuation means in the form of slidable sleeve 42 is provided for reciprocal, linear sliding movement relative to the clamping members 26, 28. In particular, inner surfaces 44, 46 of slidable sleeve 42 slidably engage with tapered outermost surfaces 38 of the clamping members 26, 28 respectively.

Sleeve 42 is associated with resilient biasing means in the form of a spring (not shown) provided in intermediate member 52. Intermediate member 52 has attachment means in the form of apertures 54 through which screws or other fixing means can be located for attachment with attachment means in the form of apertures 56 on body portion 8. The spring is located in housing 50 on intermediate member 52. An arm portion (not shown) of sleeve 42 typically engages with the spring to bias the sleeve.

Spring 50 biases sleeve 42 to an uppermost position where outermost surfaces 38 of clamping members 26, 28 are substantially enclosed within sleeve 42. In this position, clamping members 26, 28 are located in recesses 22, 24 of blade location member 12 and recesses 32, 34 of the clamping members are adjacent each other, thereby providing a clamped position.

In order to move the apparatus to an unclamped position, a user slides sleeve 42 towards lower edges 29 of clamping member 26, 28 with sufficient force to overcome the resilient bias of the spring. Members 26, 28 pivot outwardly of the clamping apparatus such that recesses 32, 34 move apart, thereby releasing any blade located therein.

Thus, in use of the clamping apparatus, saw blade 4 having a t-shaped upper end 48 is located between the blade location member 12 and the clamping members. Protruding portion 58 of blade 4 is located in aperture 18 and protruding portion 60 of blade 4 is positioned such that when clamping members 26, 28 are moved into abutting relationship with each other, protruding portion 60 locates in joined recesses 32, 34, thereby clamping the saw blade 4 in position.

Arrows 62 can be provided on outer surface of sleeve 42 to inform the user in the direction which they are required to move the same to allow clamping/unclamping thereof. They can be integrally formed with the sleeve, attached thereto or printed thereon as required.

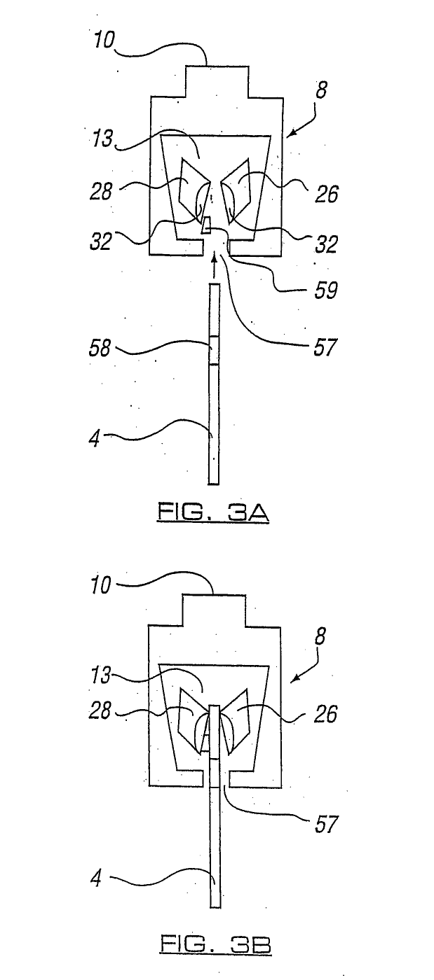

Referring to FIG. 4, there is illustrated a scrolling mechanism for jigsaw 6 to allow the orientation of blade 4 to be changed by a user during use of the jigsaw.

User actuation means in the form of a lever arm 102 is provided to move jigsaw 6 between orbital, reciprocating and/or scrolling modes of operation. Lever arm 102 is connected to a first locking member in the form of a locking pin 104 via linkage arrangement 106, such that rotation of lever arm 102 causes linear movement of the locking pin 104.

Locking pin 104 is located through a channel 108 in frame 110 and rotation of lever arm 102 moves pin 104 between a first position, wherein pin 104 protrudes from upper surface 112 of frame 110, and a second position wherein pin 104 is recessed within channel 108.

A second locking member in the form of a rotatable knob 114 is provided on top of jigsaw 6 for rotation by a user. Knob 114 is connected to blade clamping apparatus 2 via linkage arrangement 116, which in this embodiment includes an elongate reciprocating arm member or drive shaft 118. Support members 120 are provided for maintaining the position of arm member 118 and arm member 118 is freely rotatable in apertures provided in support members 120. Rotation of knob 114 rotates elongate arm member 118 and thus blade 4 to provide the required scrolling mechanism.

Knob 114 has a peripheral flange 122 provided on a lower edge thereof and a recess 124 is defined therein, the opening 126 of the recess 124 facing the frame 110. When the jigsaw is in a normal reciprocating or orbital cutting mode (i.e. not a scrolling mode), the recess 124 of knob 114 is aligned with channel 108, thereby allowing engagement of free end 128 of pin 104 in the recess 124 to lock rotatable knob 114 in position.

Appropriate markings can be provided on the outer casing of jigsaw 6 and knob 114 to allow the user to align recess 124 with channel 108. Further appropriate markings can be provided on the jigsaw casing to allow movement of lever arm 102 to the required position to ensure pin 104 is in a unlocked position for the scrolling mode or a locked position for the orbital or normal reciprocating jigsaw modes.

Light means in the form of a laser 130 can be provided on the front of jigsaw 6 to provide a visible path in front of the jigsaw for a user to follow during cutting. The path of light is typically directed downwardly towards blade clamping arrangement 2. The laser 130 can be battery powered or powered by mains power supply of jigsaw 6.

A motor 132 and gear mechanism 134 are provided for driving the reciprocating movement of the drive shaft or elongate arm 118 in a conventional manner.

Turning now to FIG. 5, the jigsaw additionally includes a support member in the form of a pivotable arm 136 for selectively engaging the saw blade during orbital operation of the jigsaw. During orbital modes, the saw blade requires additional support to increase the cutting efficiency and to prevent unnecessary flexing of the blade. The arm 136 is pivotally mounted to the sole plate 152 of the jigsaw, the sole plate being attached to the base of the jigsaw. Arm 136 pivots in a substantially vertical plane about a substantially horizontal axis. The arm 136 comprises two generally parallel arm members 137, 137′ separated by a short distance. A support roller 138 is provided between members 137, 137′ at the free end thereof closest to the saw blade. The support roller 138 is generally circular in profile and can be provided with an indent or groove around its circumference to allow an edge of the blade to locate therein. This ensures correct alignment of the member and the blade to prevent or limit lateral motion of the blade during orbital cutting operations.

Pivotable arm 136 is typically movable with respect to the tool body between a first position, wherein arm is in a forwardly position with respect to the blade so that the roller can engage the saw blade, and a second position, wherein arm is in a rearwardly position with respect to the blade and the roller is moved a spaced distance apart from the saw blade. The first position of the arm is typically selected during orbital operations of the jigsaw and the second position of the arm is typically selected during reciprocal and/or scrolling modes.

A user can manually move the pivotable arm between the first and second positions or the pivotable arm can be moved on selection of the orbital, reciprocating and/or scrolling cutting modes using lever 102 provided on the side of the tool body. The lever may be connected to arm 136 by a suitable linkage such that rotation of the lever by a user moves arm 136 into or out of engagement with the rear of the blade 4 between the first and second positions respectively.

The pivoting action of pivotable arm 136 is typically provided by intermittent engagement of a reciprocating arm 156 therewith. More specifically reciprocating arm 156 communicates with gear mechanism 134 at an end 158 thereof and the gear mechanism causes arm 156 to undergo reciprocal motion between raised and lowered positions. This reciprocal motion is typically in a direction substantially parallel to the longitudinal axis of arm or drive shaft 118.

In a raised position, arm 156 is a spaced distance apart from tab 154 provided at a free end of pivotable arm 136. In a lowered position, arm 156 engages tab 154 and exerts a downward force thereon causing pivotable arm 136 to pivot. This in turn moves support roller 138 into engagement with the rear edge of the blade 4. Arm 136 is mounted on a pin 140 such that it can rock or pivot back and forth to a required degree.

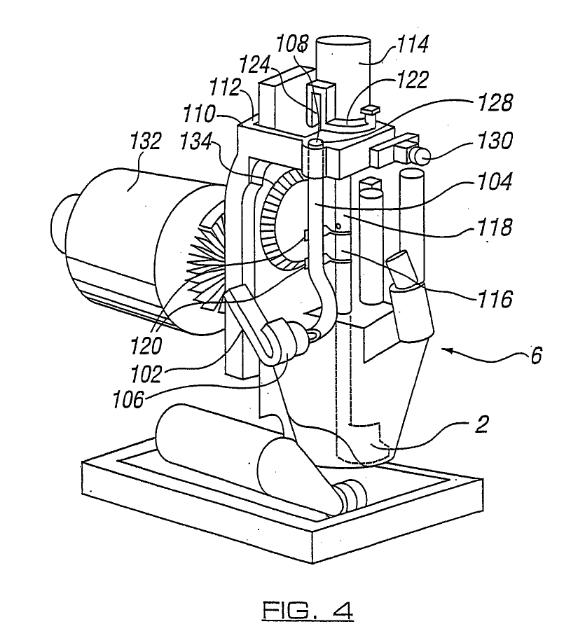

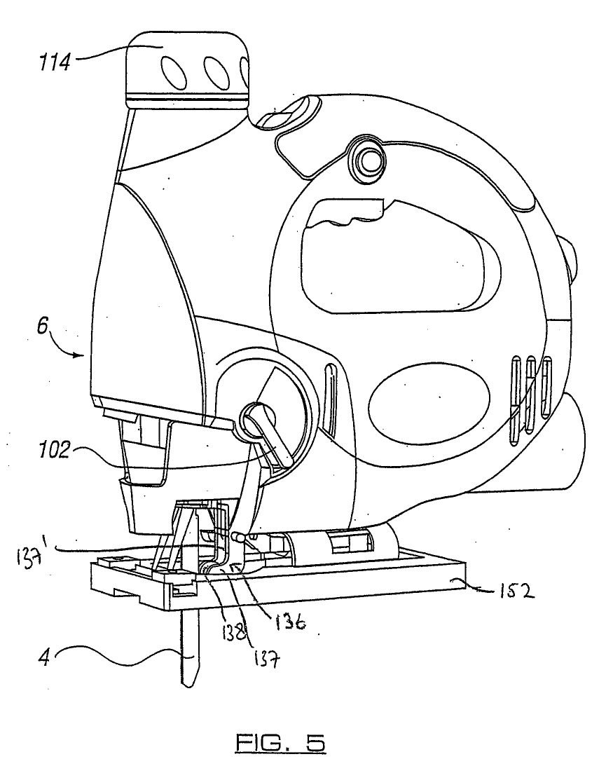

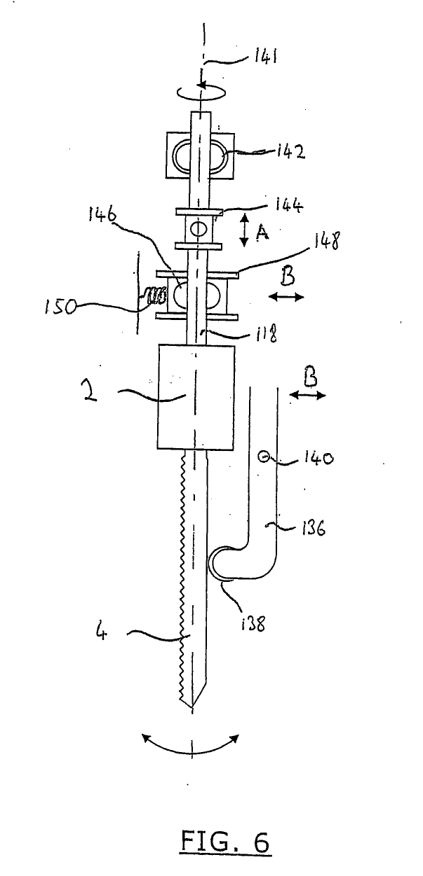

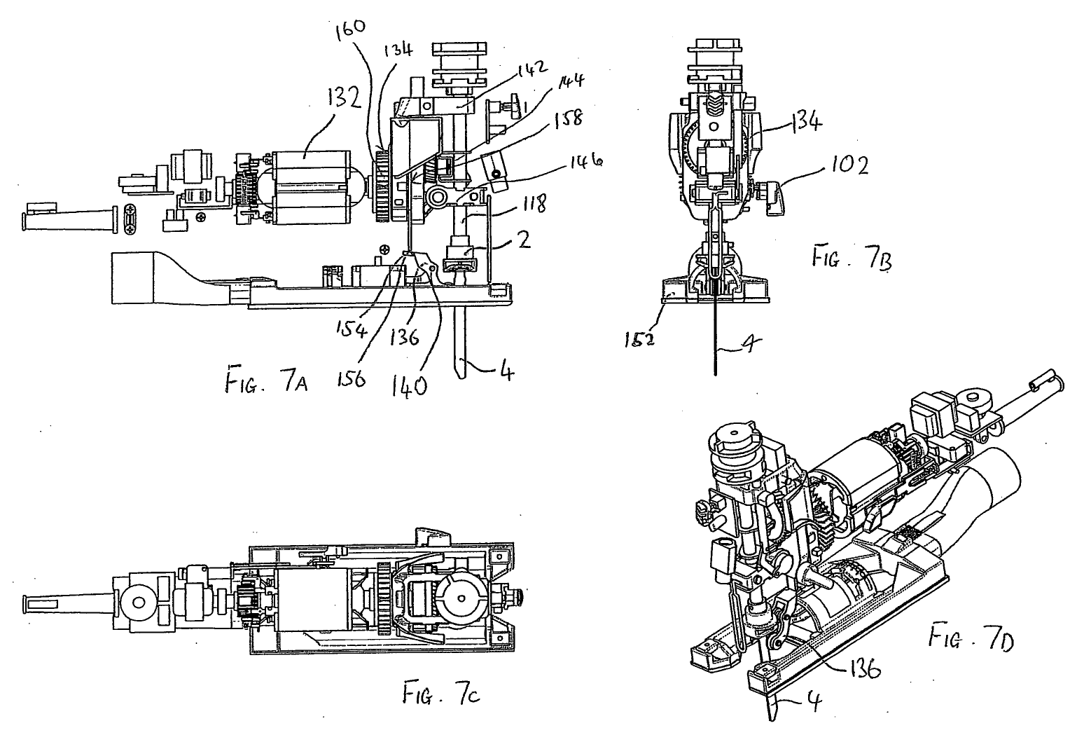

With reference to FIGS. 6 and 7a-7d, the drive shaft or elongate arm 118 is pivotally mounted to the tool at an upper bearing 142 and orbital motion is imparted to arm 118 by way of gear mechanism 134 at lower bearing 146. More specifically, the gear mechanism 134 is connected to the elongate arm 118 by way of a Scotch yoke, shown generally at 144, so as to impart reciprocating motion to the arm in the direction of arrow ‘A’ during a reciprocal operation mode. Gear mechanism 134 imparts a cyclical force in the direction of arrow B on lower spherical bearing 146. The lower bearing 146 includes a pin and moves back and forth in a guide 148, which forms part of a static housing. The lower bearing 148 is driven by a cam arrangement depending from gear mechanism 134 and is damped by spring 150.

Thus, when an orbital operation mode is selected by a user, the blade 4 is caused to be driven in an orbital motion path both by orbital motion being imparted to elongate arm 118 at lower bearing 146 and by the pivoting action of arm 136 which rocks so as to exert an intermittent, cyclic actuating force on the rear of the blade 4. The application of the force imparted by the arm 136 can be timed by an appropriate linkage to coincide with the upward stroke of the blade 4 so as to achieve an improved cutting action. Thus, whilst the blade is moving in a reciprocating manner in a vertical sense, the pivoting arm 136 and bearing 146 also impart a pivotal or orbital motion to the rear edge of the blade 4.

As shown in FIG. 6, the blade 4 is clamped to the end of elongate arm 118 by clamping apparatus 2. Elongate arm 118 is rotatable about its axis 141 as described above to allow scrolling action of blade 4. A user can rotate lever arm 102 to disengage the scrolling function and engage the orbital mechanism.

The gear mechanism is provided between motor 132 and drive shaft or elongate arm 118 and includes all mechanical linkage therebetween. This includes a fan arrangement 160 for cooling motor 132 during operation thereof.

It is envisaged that the lower end of the pivoting arm 136 may be slidably and/or pivotally attached to the foot plate 152 so as to improve support. According to such an embodiment, it will be appreciated by persons skilled in the art that the arm 136 and engagement member 138 need not be a single member and the engagement member 138 could be provided as part of the foot plate 152, and selectively actuated for orbital cutting by arm 136.

While the invention has been illustrated and described in detail in the drawings and foregoing description, the same is to be considered as illustrative and not restrictive in character. It should be understood that only the preferred embodiment has been shown and described and that all changes and modifications that come within the spirit of the invention are desired to be protected. All publications, patents, and patent applications cited in this specification are herein incorporated by reference as if each individual publication, patent, or patent application were specifically and individually indicated to be incorporated by reference and set forth in its entirety herein.

1. A jigsaw, said jigsaw including a housing and a drive mechanism disposed within said housing, said drive mechanism being provided with a mechanical connection for selectively imparting a reciprocating, scrolling and/or orbital motion to a drive shaft of the jigsaw and/or a saw blade attached to the drive shaft of the jigsaw during use thereof, and wherein said jigsaw includes a support member for selective engagement with a part of said saw blade to provide support to said blade during said reciprocal, scrolling and/or orbital motion.

2. A jigsaw according to claim 1 wherein the support member is arranged to exert a force to the blade during orbital motion.

3. A jigsaw according to claim 2 wherein the force is exerted by the support member to a rear edge of the blade during orbital motion.

4. A jigsaw according to claim 1 wherein the support member is moved to a position remote from the blade during scrolling and/or reciprocal motion so that the support member does not engage the blade.

5. A jigsaw according to claim 1 wherein the support member is selectively connected in the force path between the drive mechanism and the blade and is driven by said drive mechanism during orbital cutting so as to exert a varying force on the blade.

6. A jigsaw according to claim 1 wherein the support member is pivotally mounted on the jigsaw.

7. A jigsaw according to claim 6 wherein the support member is pivotally mounted to a sole or foot plate provided on or forming part of a base of the jigsaw.

8. A jigsaw according to claim 1 wherein the support member pivots between a first position, wherein the support member contacts the blade, and a second position, wherein the support member is a spaced distance from the blade.

9. A jigsaw according to claim 1 wherein the support member includes a roller member and the roller member engages the saw blade in use.

10. A jigsaw according to claim 9 wherein the roller member is mounted to a free end of a support arm and the support arm is directly or indirectly pivotally mounted to the jigsaw.

11. A jigsaw according to claim 1 wherein the support member drives, at least in part, the orbital motion of the saw blade when the jigsaw is placed in an orbital operational mode.

12. A jigsaw according to claim 1 wherein the support member is caused to pivot as a result of actuation by movable linkage forming part of said drive mechanism.

13. A jigsaw according to claim 12 wherein the movable linkage includes a reciprocating arm which intermittently engages a part of said support member when in an orbital mode to allow pivoting of said support member.

14. A jigsaw according to claim 13 wherein the reciprocating arm moves in a forwards and backwards direction substantially parallel to the longitudinal axis of the drive shaft to which the saw blade is attached to in use.

15. A jigsaw according to claim 1 wherein the support member passively supports the saw blade during orbital motion by resisting orbital motion to a required degree.

16. A jigsaw according to claim 1 wherein use selection means are provided on the tool to allow a user to select between orbital, reciprocal and/or scrolling modes of operation of the tool corresponding to orbital, reciprocal and/or scrolling motion of said saw blade.

17. A jigsaw according to claim 1 wherein the drive means is arranged so as to impart orbital motion to a part of said drive shaft during orbital operation of said jigsaw.

18. A jigsaw according to claim 17 wherein the drive shaft is supported in the jigsaw by at least upper and lower bearing means and the drive means imparts orbital motion to the lower bearing means.

19. A reciprocating cutting tool configured for orbital cutting, comprising:
a housing;
a power source disposed in said housing;
a main linkage connected to said power source and to a blade for driving the blade in a vertically reciprocating motion;
a foot plate connected to said housing and including a portion in operational proximity to the blade; and
a swivel bracket connected to said foot plate and disposed to exert a force to a rear edge of the blade.

20. The tool of claim 19 further including a swivel linkage driven by said main linkage for exerting an eccentric force on said swivel bracket for creating said force on the blade.

21. The tool of claim 20 wherein said foot plate is laterally slidable on said housing to move said swivel bracket out of engagement with the blade.

22. The tool of claim 21 wherein said swivel bracket has a swivel bracket holder connected to said foot plate by a pair of tabs so that said swivel bracket moves with said foot plate.

23. The tool of claim 21 further including a cam lever lock for releasably locking said foot plate and said swivel bracket in relation to said housing.

24. The tool of claim 21 wherein said main linkage includes a plunger configured for reciprocating movement relative to said housing and having an end configured for accommodating the blade, said plunger convertible for scrolling or standard reciprocating operation upon the sliding of said swivel bracket out of engagement.

25. The tool of claim 20 wherein said swivel linkage includes a reciprocating pusher driven by said main linkage along a longitudinal axis which parallels the movement of the blade.

26. The tool of claim 25, wherein said swivel bracket includes a portion configured for operating in a see-saw motion when engaged by said pusher.

27. The tool of claim 25 wherein said swivel bracket includes a holder configured for mounting to said foot plate, and a rocker member pivotally joined to said holder, the rocker member having a blade engaging end for engaging the rear of the blade to create the orbital motion, and a landing end opposite the blade engaging end, said landing end being biased toward said housing, said pusher engaging said landing end to pivot the blade engaging end in an arc against the blade, causing the orbital action.

28. The tool of claim 27 further including a roller on the blade engaging end of said rocker, said roller configured for rotatably engaging the blade.

29. The tool of claim 19 wherein said swivel bracket is configured to engage the blade at a location which is generally coplanar with said foot plate.

30. The tool of claim 19 wherein said main linkage includes an elongate plunger operated by a scotch yoke mechanism for vertical reciprocating motion relative to said housing, a lower end of said plunger configured for receiving the blade.

31. The tool of claim 30 further including a bottom bushing supporting a lower end of said plunger and accommodating lateral movement of the plunger.

32. The tool of claim 31 wherein said bottom bushing includes a track and said plunger is equipped with a bushing block having at least one surface for engaging said track for guiding lateral movement of said plunger.

33. The tool of claim 32 wherein said track and said bushing block have complementary hemispherical surfaces.

34. The tool of claim 31 further including an orbital control disposed in said lower bushing for controlling the amount of lateral movement of said plunger.

35. The tool of claim 34 wherein said orbital control is an orbital pin transversely mounted in said lower bushing and having at least one cam surface for selectively limiting the amount of lateral movement of said plunger depending on the rotational position of said orbital pin.

36. The tool of claim 35 wherein a portion of said at least one cam surface of said orbital pin permits no lateral movement of said plunger, so that said plunger may be converted to scrolling or standard reciprocating operation.

37. The tool of claim 19 further including a plunger having a first end connected to a spherical bearing, and a second end connectable to the blade, and including a spherical bearing for supporting said plunger near said second end during said orbital motion.

38. The tool of claim 37 wherein said spherical bearing includes a pair of spaced spherical surfaces secured to said plunger and a track defining a lateral forward and back range of movement for said surfaces, said track including concave surfaces configured for accommodating lateral movement of said spherical surfaces as said plunger affects said orbital movement.

39. The tool of claim 38 further including an orbital pin which is selectively rotatable to adjust the amount of travel of said spherical surfaces and said plunger in said track from no movement to full orbital movement.

40. An electric jigsaw, comprising:
a housing;
a power source disposed within said housing;
a main linkage disposed within said housing and connected to said power source;
a plunger secured within said housing and connected to said linkage for reciprocating, pivotal and rotational movement, and having an end configured for receiving a blade; and
a selector mechanism for selecting between said pivotal and said rotational movement of said plunger, and including a swivel bracket mechanism selectively positioned to exert a force to a rear edge of the blade and cause said plunger to exhibit pivotal movement;
wherein said pivotal movement relates to orbital blade motion, and said rotational movement relates to scrolling blade motion.

41. The jigsaw of claim 40 further including a foot plate connected to said housing, said swivel bracket mechanism being operatively connected to at least one of said housing and said foot plate.

42. The jigsaw of claim 40 wherein said selector mechanism includes a transverse orbit pin and a scroll lock arm, said scroll lock arm being operatively connected to said orbit pin and being adjustable at least between a first position for preventing scrolling during pivoting motion by said plunger, and a second position preventing pivoting action and permitting rotational motion.

43. The jigsaw of claim 42 wherein said selector mechanism further includes a bottom bushing supporting a lower end of said plunger and accommodating pivotal movement of the plunger, said bottom bushing includes a track and a bushing block having at least one surface for engaging said track for guiding pivotal movement of said plunger.

44. The jigsaw of claim 43 wherein said track and said bushing block have complementary hemispherical surfaces.

45. The jigsaw of claim 42 wherein said orbit pin is transversely mounted in said bottom bushing.

46. An electric jigsaw, comprising:
a housing;
a power source disposed within said housing;
a main linkage disposed within said housing and connected to said power source;
a plunger located within said housing and having an end configured for receiving a blade, said plunger being connected to said linkage and being capable of generally vertical reciprocating movement, rotational scrolling movement and orbital movement; and
a selector mechanism for alternatively selecting scrolling and orbital movement, said selector mechanism having a rocker member selectively positioned to exert a force to a rear edge of the blade.

47. An electric jigsaw having scrolling and orbital operational capability, comprising:
a housing;
a motor in said housing;
a generally vertical elongated reciprocating plunger to which a blade can be attached at its lower end;
a drive mechanism interconnecting said motor and said plunger and supporting said plunger to facilitate reciprocating, scrolling and orbital movement, said mechanism being configured to exert a force to an attached blade during orbital operation; and
a selector mechanism for alternatively selecting scrolling and orbital operation.
